(19) United States
(12) Patent Application Publication
(10) Pub. No.: US 2009/0267516 A1
(43) Pub. Date: Oct. 29, 2009

(54) CERAMIC METAL HALIDE DAYLIGHT LAMP

(75) Inventors: Junming Tu, Bath, NY (US); Jay Joseph Palmer, Hammondsport, NY (US); Gregory Allen Golding, Dundee, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/440,039

(22) PCT Filed: Sep. 27, 2007
(86) PCT No.: PCT/IB2007/053928

§ 371 Date: Mar. 5, 2009

Related U.S. Application Data
(60) Provisional application No. 60/827,448, filed on Sep. 29, 2006.

(51) Int. Cl. H01J 61/20

(52) U.S. Cl. 313/641

(57) ABSTRACT

A ceramic metal halide lamp (1) of the present invention has a ceramic discharge tube (3) and two electrodes (4, 5) mounted in an outer glass envelope (2). The discharge tube (3) is filled with mercury, a starting gas such as xenon and a mixture of metal iodides including in weight percent (wt. %): about 5-35% sodium iodide, about 1-6% thallium iodide, about 55-86% thulium iodide and/or dysprosium iodide, about 0-15% calcium iodide and about 0-31% of dysprosium and/or holmium iodide. The lamp has a light output characterized by a relatively high color temperature (around 5000K or higher), making it suitable for use as a daylight lamp.

This invention relates in general to high intensity discharge (HID) lamps, and in particular, to a ceramic metal halide lamp with a high color temperature.

Some outdoor lighting applications such as city beautification prefer to use lamps with a high color temperature. Several lighting manufacturers make quartz metal halide HID lamps with a high color temperature of around 5000K to meet the marketing requirements.

These quartz metal halide lamps are referred to as ‘Daylight’ or ‘Natural Daylight’ lamps, since the emission spectra of their lumen outputs is closer to natural daylight than lamps with lower color temperatures. However, these quartz metal halide lamps have a large initial color spread from lamp to lamp and a large color shift over their life. Moreover, their lumen output, efficacy and lumen maintenance over their life is not satisfactory.

There is a need in the marketplace for a high color temperature lamp with a small color variation from lamp to lamp and a small color shift over life, as well as satisfactory lumen output, efficacy and lumen maintenance.

EP0382516 discloses a quartz metal halide lamp having a quartz arc tube of ellipsoidal shape with suitable amounts of a noble gas, mercury and a metal halide mixture sealed in the arc tube. The metal halides include a rare earth metal halide, e.g. an iodide of dysprosium (DyI₃), holmium (HoI₃) and thulium (TmI₃), and also include iodides of cesium (CsI) and thallium (TlI). In addition, a tin halide, e.g. SnI₂, is also present. The weight ratio of each halide apart from the tin halide is as follows: DyI₃:HoI₃:TmI₃:CsI:TlI=20:21:22:17:20. The total amount of the metal halides other than tin halide is 2.0 mg/cc. The amount of tin halide (SnI₂) is 0.5 mg/cc. Thus, the total amount of each constituent of the metal halide mixture expressed in wt. % is: DyI₃=16; HoI₃=16.8; TmI₃=17.6; CsI=13.6; TlI=16; and SnI₂=20.

The initial characteristics of the lamp are: luminous flux 13500 μm/W; lamp efficacy 90 μm/w; correlated color temperature (CCT) 5000K; average color rendering index (CRI) 85; and lumen maintenance 85% after 1000 hours of continuous operation.

The lumen maintenance is much improved over the Daylight lamps, but it is still much lower than is desired, e.g., 90% after 1000 hrs. or even 2000 hrs. of operation.

According to one aspect of the invention, there is provided a metal halide lamp having a high color temperature with high efficacy and high lumen maintenance, as well as improved color stability. The lamp of the present invention has a ceramic discharge tube filled with a starting gas such as xenon, mercury and a mixture of metal halides, e.g., iodides, including sodium iodide, thallium iodide, a relatively large amount (i.e., about 55 to 86%) of a first rare earth halide component, either thulium iodide or gadolinium iodide or a mixture of these two rare earth iodides.

The metal halide mixture may also contain calcium iodide, and a second rare earth halide component, either dysprosium iodide or holmium iodide or a mixture of these two rare earth iodides.

In accordance with one embodiment of the invention, a ceramic metal halide lamp has a ceramic discharge tube enclosing a gas-tight discharge space, a pair of discharge electrodes extending into the discharge space, a fill capable of sustaining an arc discharge in the discharge space, the fill comprising mercury, a starting gas such as xenon and a mixture of metal iodides including in weight percent (wt. %): about 5-35% sodium iodide, about 1-6% thallium iodide, about 55-86% thulium iodide and/or gadolinium iodide, about 0-15% calcium iodide and about 0-31% of dysprosium and/or holmium iodide. The lamp has a light output characterized by a relatively high color temperature (around 5000K or higher), making it suitable for use as a daylight lamp.

In a preferred embodiment, the metal iodides in the fill of the discharge tube comprise in weight percent: 5 to 20% sodium iodide; 1 to 5% thallium iodide; 5 to 15% calcium iodide; 0-31% dysprosium iodide and/or holmium iodide; and 60 to 86% thulium iodide.

When the metal iodides in the fill of the discharge tube comprise in weight percent: 6% sodium iodide; 7% calcium iodide; 1% thallium iodide; 82% thulium iodide; 2% dysprosium iodide and 2% holmium iodide, the resulting lamp characteristics are: a correlated color temperature (CCT) of 5000K, an efficacy of 85 μm/W to 90 μm/W, a color rendering index (CRI) of 85 to 90, a mean perceptible color difference (MPCD) of less than 10, and a lumen maintenance of 91% at 2,000 hrs. The high efficacy and high maintenance are due in part to the higher chemical resistance to chemical fillings and higher operating temperature (˜200° C. higher) of ceramic discharge tubes than quartz glass discharge tubes, which enables higher performing metal halide mixtures.

In another preferred embodiment, the metal iodides in the fill of the discharge tube comprise in weight percent: 33-34% sodium iodide; 5-6% thallium iodide; and 60-62% gadolinium iodide, resulting in a correlated color temperature (CCT) of about 5900K, an efficacy of about 77 lm/W, a color rendering index (CRI) of about 91, and MPCD less than 10.

These and other aspects of the invention will be further elucidated with reference to the Figures, in which:

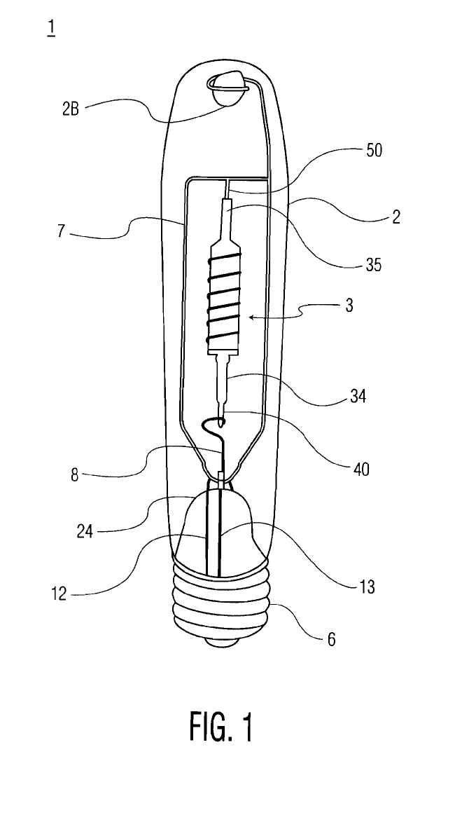

FIG. 1 is a schematic illustration of one embodiment of a ceramic metal halide lamp of the invention;

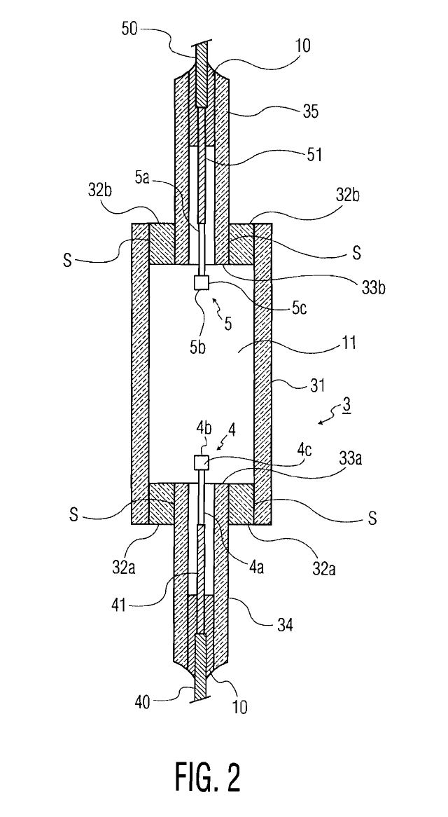

FIG. 2 is a schematic illustration of one embodiment of a ceramic discharge tube suitable for use in the lamp of FIG. 1;

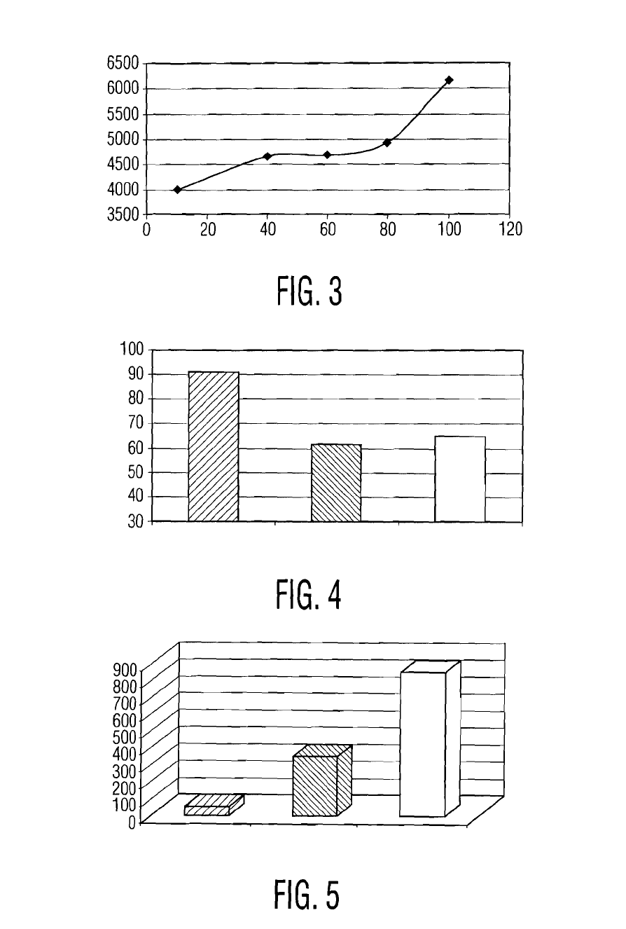

FIG. 3 is a line graph showing the variation color temperature in K of a ceramic metal halide lamp versus the amount of TmI₃ in weight percent in the fill of the discharge tube of the lamp;

FIG. 4 is a bar graph of lumen maintenance at 2000 hrs. Of a lamp of the invention and of two different quartz metal halide lamps of the prior art; and

FIG. 5 is a bar graph of color shift from 100 hrs. to 2000 hrs. of the lamps of FIG. 4.

The Figures are diagrammatic and not necessarily drawn to scale.

One embodiment of a metal halide lamp of the invention is shown in FIG. 1. The lamp 1 includes an outer glass bulb 2 enclosing a vacuum space and having an inwardly projecting dimple 2B at one end and a gas-tight press seal 2A attached to a standard base 6 and at the other end. A ceramic arc tube 3 made of a polycrystalline alumina material is mounted in the vacuum space of the glass outer bulb 2 by a frame-shaped mounting member 7 and another mounting member 8. The mounting members 7 and 8 are secured at one end by press seal 2A, and are electrically connected to base 6 by leads 12 and 13.

The arc tube construction is shown in FIG. 2. A discharge vessel 3 encloses a discharge space 11. The discharge vessel has a ceramic wall 31 and is closed by ceramic plugs 32a and 32b and close fitting plug extensions 34 and 35. A pair of electrodes 4 and 5 include a base portion (4a, 5a) and a tip portion (4b, 5b) which is located inside the discharge space 11, and is connected to an electric conductor (40, 50) by way of a lead through element (41, 51). The lead through element (41, 51) projects through the ceramic plug (32a, 32b) and a portion of the plug extension (34, 35) where it is connected to the electric conductor (40, 50). The discharge space 11, which has a length L and a diameter D, is sealed in a gas-tight manner by way of a sealing ceramic 10, which fills the space between the plug extension (34, 35) and the lead through element (41, 51) and conductor (40, 50) at the area of their connection.

The arc tube is filled with mercury, a starting gas for assisting lamp ignition and a mixture of metal iodides. The starting gas is preferably a mixture of about 99.99% xenon and a trace amount of 85 Kr radioactive gas, but may also be a mixture of the noble gases Ar and Kr instead.

The mixture of metal iodides comprises sodium iodide (NaI), thallium iodide (TlI), and a relatively large amount (55-86 wt. %) of at least a first rare earth halide component which is thulium iodide (TMI₃) and/or gadolinium iodide (GdI₃). The mixture may also contain calcium iodide (CaI₂) and a second rare earth halide component which is dysprosium iodide (DyI₃) and/or holmium iodide (HoI₃).

As is known in the art of ceramic metal halide lamps, sodium iodide is added to the salt mixture in order to broaden the arc. For this purpose, sodium iodide can range in amount from about 5 to 35 wt. %. Without sodium iodide, or with too little sodium iodide, the arc is too constricted, and in the case of horizontal orientation of the arc tube, the arc tends toward the upper wall of the discharge tube, leading to high wall temperatures and the possibility of cracking. Too much sodium iodide will result in a lowering of the color temperature of the light output of the lamp.

Calcium iodide provides high intensity line emissions in various colors, as well as a continuous spectrum of lower intensity light emission, which contributes to the color rendering index (CRI). Calcium iodide also dilutes the rare earth iodides to reduce chemical corrosion of the main wall and extended plug of the ceramic vessel, and can range in amount from 0 to about 15 wt. %, above which the desired color temperature is not obtained.

Thallium iodide also provides high intensity line emissions mainly in green. Thallium iodide is present in the amount of about 1 to 6 wt. %, and is used mainly to boost lumen output and lamp efficacy. Too much thallium will cause a greenish color and tends to have a high MPCD.

The first rare earth halide component thulium iodide and/or gadolinium iodide is primarily responsible for the blue emissions and the high color temperature of the lamp, enabling its use in daylight applications. Thulium iodide and/or gadolinium iodide can range in amount from about 55 to 86 wt. % of the salt mixture, below which the desired lamp color temperature is not achieved, and above which excessive wall corrosion may occur, due in large part to the formation of rare earth aluminates, leading to a shortened lamp life.

In general, gadolinium iodide results in a higher color temperature than does thulium iodide. For example, about 61 wt. % gadolinium iodide alone can result in a color temperature as high as 5900K, whereas about 82% thulium iodide alone results in a color temperature of around 5000K. A mixture of thulium and gadolinium iodides can result in a color temperature intermediate between these values. Thus, the relative amounts of thulium and gadolinium can be adjusted to achieve a desired color temperature, e.g., 5600K, the color temperature of natural daylight.

The second rare earth halide component, dysprosium iodide and/or holmium iodide, is added for the purpose of obtaining or augmenting a continuous spectrum of radiation throughout the visible range, resulting in a high color rendering index (CRI). The second rare earth halide component can also be added to dilute the first rare earth halide component, thus reducing the color temperature. The second rare earth halide component can range in amount from 0 to about 31 wt. %, above which the formation of rare earth aluminates can contribute to erosion of the ceramic wall and plug.

The influence of the TmI₃ percentage on color temperature is shown in FIG. 3. As may be seen, color temperature increases from about 4000K at about 10 wt. % TmI₃ to about 6200K at 100 wt. % TmI₃. Color temperature ranges from about 4700K to about 5500K between 42 and 90 wt. % TmI₃, and is about 5000K at about 80 wt. % TmI₃.

### EXAMPLE 1

A group of ceramic metal halide lamps having a power rating of 400 W, were prepared for evaluation, the fill containing Xe at a fill pressure is 85 torr, mercury (Hg) dosed at 3.2 mg, and 35 mg of a mixture of metal iodides in the following weight percentages:

Sodium iodide (NaI): 6%
Calcium iodide (CaI₂): 7%
Thallium iodide (TlI): 1%
Thulium iodide (TmI₃): 82%
Dysprosium iodide (DyI₃): 2%
Holmium iodide (HoI₃): 2%

The lamps had an average efficacy of 86 μm/W, a CCT of 5000K, a CRI of 87, MPCD of 4.7, and voltage of 89V. At 2000 hrs, this group had a luminous flux of 34,400 μm, a small color shift (55K) and good lumen maintenance (91%).

Table 1 shows the color temperature shift and lumen maintenance from 100 hrs to 2000 hrs for Example 1 of this invention and two manufacturers' quartz metal halide Daylight 400 W lamps. It is clear that the invention reduces the color shift and improves lumen maintenance significantly.

TABLE 1

| Manufacturer | Color shift | Lumen maintenance |
|---|---|---|
| This invention | 55 K | 91% |
| Manufacturer 1 | 350 K | 62% |
| Manufacturer 2 | 850 K | 65% |

These results are presented graphically in FIGS. 4 and 5.

A comparison of lamp characteristics at 100-h and maintenance at 2000-h for two lighting manufacturers' 400 W and 250 W lamps as well as a lamp of the invention (Example 1) is given in Table 2. An improvement in both efficacy and lumen maintenance is shown.

TABLE 2

| Manufacturer/Lamp type | Efficacy | CCT | CRI | M % at 2000 hrs |
|---|---|---|---|---|
| Mfgr 1 Daylight 250 W | 79 | 6000 K | 75 | 79% |
| Mfgr 1 Daylight 400 W | 82 | 6100 K | 75 | 62% |
| Mfgr 2 Daylight 400 W | 80 | 5450 K | 88 | 65% |
| Mfgr 2 Daylight 250 W | 80 | 4980 K | 88 | 84% |
| Lamp of this invention | 86 | 4931 K | 87 | 91% |

### EXAMPLE 2

Four ceramic metal halide lamps similar to those of Example 1 but having a 150 W power rating were prepared with a metal halide salt mixture as follows: 33.6 wt. % NaI, 5.4 wt. % TlI and 61 wt. % GdI₃. The average photometric data were as follows: CRI=91.1; CCT=5905K; MPCD=8.4; voltage=100V; efficacy=77.1 μm/W; luminous flux=11,565 μm.

The invention has necessarily been described in terms of a limited number of embodiments. From this description, other embodiments and variations of embodiments will become apparent to those skilled in the art, and are intended to be fully encompassed within the scope of the invention and the appended claims. For example, while the description of the metal halide mixture has largely been in terms of metal iodides, since iodides in general result in higher vapor pressures in the discharge space, leading to higher lumen output, certain other metal halides such as thulium bromide may be at least partially substituted for the thulium iodide, which may be beneficial to reduce lamp voltage variations in different lamp orientations.

Moreover, while the preferred embodiments have been described as including discharge electrodes, it will be realized that electrodeless operation in the known manner is also possible.

1. A ceramic metal halide lamp comprising a ceramic discharge tube (3) enclosing a gas-tight discharge space (11), a fill capable of sustaining an arc discharge in the discharge space (11), the fill comprised of a starting gas, mercury and a mixture of metal iodides, the metal iodides comprising sodium iodide, thallium iodide and at least a first rare earth halide component comprising at least one member selected from the group consisting of thulium iodide and gadolinium iodide, characterized in that the thulium iodide and/or gadolinium iodide is present in an amount within the range of about 55 to about 86 wt. % of the metal iodide mixture, whereby the light emission from the lamp has a high color temperature.

2. A ceramic metal halide lamp as claimed in claim 1, wherein sodium iodide is present in an amount within the range of about 5 to 35 wt. % of the metal iodide mixture.

3. A ceramic metal halide lamp as claimed in claim 1, wherein thallium iodide is present in an amount within the range of about 1 to 6 wt. % of the metal iodide mixture.

4. A ceramic metal halide lamp as claimed in claim 1, wherein calcium iodide is present in an amount within the range of about 0 to 15 wt. % of the metal iodide mixture.

5. A ceramic metal halide lamp as claimed in claim 1, wherein a second rare earth halide component comprising at least one member selected from the group consisting of dysprosium iodide and holmium iodide is present in an amount within the range of about 0 to 31 wt. % of the metal iodide mixture.

6. A ceramic metal halide lamp as claimed in claim 1, wherein the mixture of metal iodides comprises in wt. %:5 to 20% sodium iodide; 1 to 5% thallium iodide; 5 to 15% calcium iodide; 0-31% dysprosium iodide and/or holmium iodide; and 60 to 86% thulium iodide.

7. A ceramic metal halide lamp as claimed in claim 1, wherein the mixture of metal iodides consists essentially of in wt. %: 6% sodium iodide; 1% thallium iodide; 7% calcium iodide; 2% dysprosium iodide; 2% holmium iodide; and 82% thulium iodide.

8. A ceramic metal halide lamp as claimed in claim 1, wherein the mixture of metal iodides comprises in wt. %: 33-34% sodium iodide; 5 to 6% thallium iodide; and 60 to 62% gadolinium iodide.

9. A ceramic metal halide lamp as claimed in claim 1, wherein the ceramic discharge tube (3) is mounted in a gas-tight outer glass envelope (2), and the envelope (2) is mounted on a lamp base (6).

10. A ceramic metal halide lamp as claimed in claim 10, wherein a pair of discharge electrodes (4, 5) extend into the discharge space (11).

11. A ceramic metal halide lamp as claimed in claim 1, wherein at least a portion of the thulium iodide is replaced by thulium bromide.
